(19) United States
(12) Patent Application Publication
(10) Pub. No.: US 2008/0016572 A1
(43) Pub. Date: Jan. 17, 2008

(54) Malicious software detection via memory analysis

(75) Inventors: Ryan M. Burkhardt, Redmond, WA (US); Alexey Polyakov, Sammamish, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/485,066

(22) Filed: Jul. 12, 2006

(51) Int. Cl. G06F 12/14

(52) U.S. Cl. 726/24

(57) ABSTRACT

To detect the presence of malicious software in a system, selected data in memory of the system is stored in a designated storage location and analyzed by a known safe operating system. In an example configuration, a snapshot of system memory is downloaded to a dedicated device coupled to the motherboard of the system. A clean, uncorrupted operating system is loaded into the dedicated device, and the snapshot is analyzed utilizing the clean operating system. If malicious software is detected, the system is repaired using the clean operating system. In an example embodiment, this process is initiated when the system goes into a hibernation state, and/or during a system restoration operation.

### TECHNICAL FIELD

The technical field generally relates to computer-related security and more specifically relates to detection of malicious software.

### BACKGROUND

Malicious software, referred to as malware, is prevalent in today's computing environment. Malware is not always detectable by anti-malware utilities, such as anti-virus and anti-spyware applications. This is particularly true for a type of malware, know as a rootkit. Rootkits are parasitic. A rootkit typically compromises an operating system and exploits system resources. Rootkits generally do not create new objects, but rather use objects that are provided by the operating system. Rootkits intercept requests from applications and can thus prevent self detection. Rootkits often intercept requests for file system and memory information. Rootkits can disable security applications such as antivirus applications, antispyware applications, security monitors, and the like. Once malware, such as a rootkit or the like, has been injected into a system, it can wreak havoc with the system, while remaining undetected.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

To detect the presence of malicious software (malware) in a system, selected data in memory of the system is stored in a designated storage location. The designated location can comprise external storage (e.g., flash drive memory, hard disk memory, or the like), a segregated portion of system memory, memory on a designated hardware device coupled to the system processor, or a combination thereof, for example. The selected data is analyzed for malware utilizing a known clean operating system. The clean operating system can be downloaded and/or exist in the designated storage. For example, a segregated hardware device, coupled to the motherboard of the system can comprise the designated storage and the clean operating system. Upon analysis, if malware is detected, the malware is removed from the system utilizing the clean operating system. In an example embodiment, selected data is analyzed upon the occurrence of specific events, such as during system hibernation, during system resume (exiting hibernation), during system restore, and/or as selected by a user.

### BRIEF DESCRIPTION OF THE DRAWINGS

The foregoing summary, as well as the following detailed description, is better understood when read in conjunction with the appended drawings. For the purpose of illustrating malicious software detection via memory analysis, there is shown in the drawings exemplary constructions thereof; however, malicious software detection via memory analysis is not limited to the specific methods and instrumentalities disclosed.

FIG. 1 is a flow diagram of an example process for detecting malicious software via memory analysis.

FIG. 2 is an example computing environment for detecting malicious software via memory analysis.

### DETAILED DESCRIPTION OF ILLUSTRATIVE EMBODIMENTS

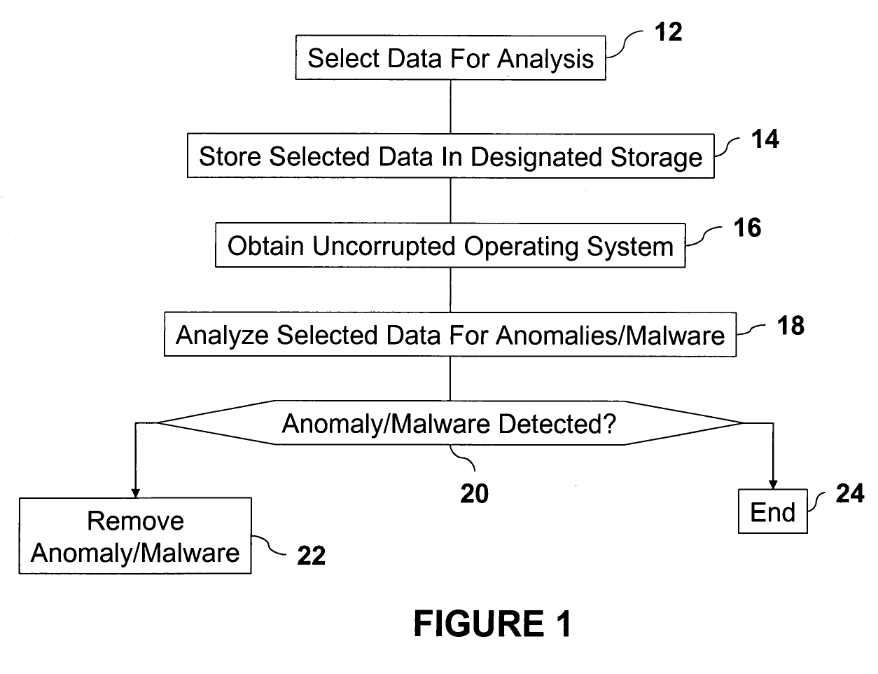

FIG. 1 is a flow diagram of an example process for detecting malicious software. Data is selected to be analyzed for anomalies at step 12. Any appropriate data can be selected for analysis. Any data that can be copied and stored in another storage location is appropriate. For example, rootkits are known to reside in system memory. Thus, there may be an advantage to the selected data comprising data stored in system memory.

The selected data is stored in designated storage at step 14. That is, the selected data is offloaded to another storage location with the intention of scanning the data for anomalies. An anomaly is an indication that the selected data may comprise malicious software. The selected storage can comprise any appropriate storage. For example, the designated storage can comprise external memory, a segregated portion of system memory, and/or memory in a dedicated hardware device coupled to a system processor. Examples of external storage include a hard disk memory, a flash device memory, an optical disk memory, a magnetic disk memory, a server, a database, or a combination thereof. In an example configuration, segregated system memory comprises a portion of system memory that is dedicated to the analysis of anomalies. For example, the segregated memory can comprise a separate partition dedicated to anomaly detection. In this example embodiment, the segregated memory is not utilized for other system operations. Further, the segregated memory is not utilized by applications, other than those used to detect anomalies. In another example embodiment, a hardware device dedicated to analyzing data for anatomies is coupled to the system, such as coupled to the mother board of the system for example. In this example embodiment, the dedicated device comprises the designated storage.

A clean, uncorrupted operating system is obtained at step 16. And, the selected data is analyzed for anomalies utilizing the uncorrupted operating system, along with anomaly detect software, at step 18. An uncorrupted operating system does not comprise malicious software. The uncorrupted operating system can be downloaded and/or be resident with the designated storage. For example, in a scenario in which the uncorrupted operating system is resident with the designated storage, the selected data can comprise a snapshot of system memory. The snapshot can be offloaded to an external memory device such as a flash memory device. The flash memory device can have an uncorrupted operating system stored therein. The uncorrupted operating system can be used, along with anomaly detection software, to detect anomalies/malware in the snapshot (step 18). In an example scenario, in which the uncorrupted operating system is downloaded, the selected data can comprise a snapshot of system memory, the snapshot can be offloaded to an external memory device such as a flash memory device, and the uncorrupted operating system can be downloaded via a network, or the like, to the flash memory device. The downloaded uncorrupted operating system can be utilized, along with anomaly detection software, to detect anomalies/malware in the snapshot (step 18).

In an example embodiment, a dedicated device is coupled to the system processor for analyzing the selected data for anomalies/malware. The dedicated device can comprise an uncorrupted operating system and/or receive an uncorrupted operating system. For example, the dedicated device can comprise read only memory (ROM) having an uncorrupted operating system stored therein. The dedicated device could also comprise anomaly detection software stored in the ROM. In another example embodiment, the uncorrupted operating system can be loaded into the dedicated device. The dedicated device can then receive the selected data and analyze the selected data (step 18) utilizing the uncorrupted operating system along with the anomaly detection software.

It is determined if an anomaly is detected at step 20. If an anomaly is not detected (step 20), the process ends at step 24. Optionally, a message can be provided indicating that no anomalies were detected at step 24. If an anomaly is detected (step 20), the anomaly is removed at step 22. In an example embodiment, the anomaly and/or the malware can be removed from the selected data, and the clean selected data can be reloaded into the system. In another example embodiment, because the system is known to be infected with malware, the malware can be directly removed from the system utilizing the uncorrupted operating system. In yet another embodiment, for example, the selected data can comprise a portion of system memory. The selected data can be copied and provided to the designated storage for analysis. If an anomaly is detected, it is inferred that the system is infected with malicious software. The entire system memory can than be provided to the designated storage, and the entire system, as well as the system resident on the hard drive memory, can be purged of malware. The clean system memory can then be reloaded into the system.

The process of detecting malicious software via memory analysis can be initiated at any appropriate time. For example, the process can be initiated when a system is entering or leaving/exiting a hibernation state, during system restoration operations, or at any time designated by a user.

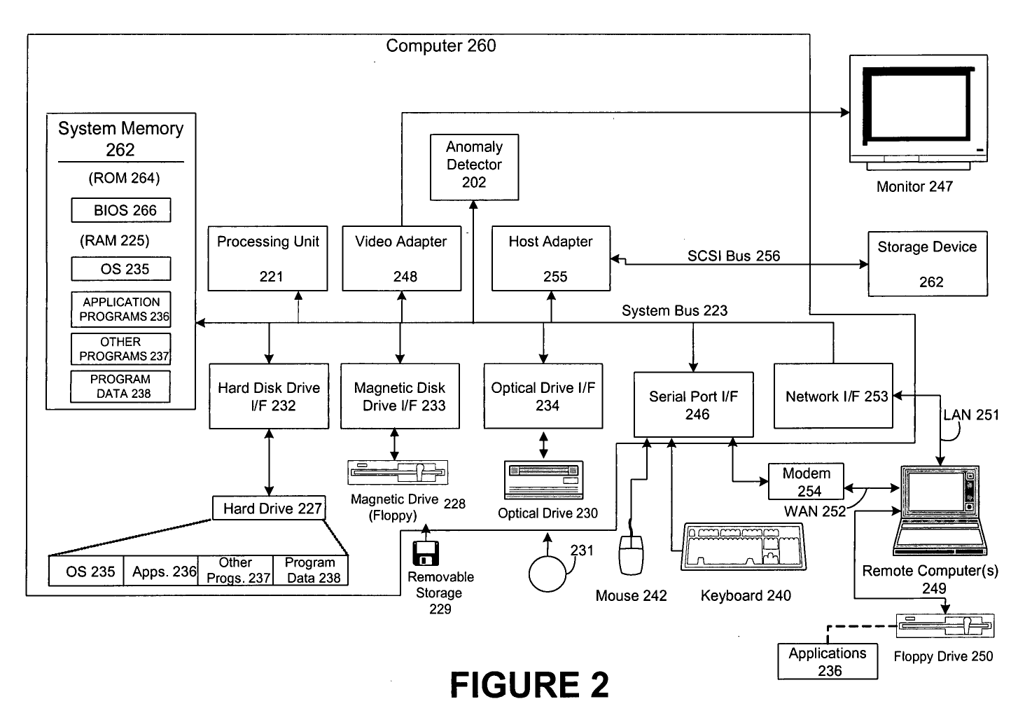

FIG. 2 is an example computing environment for detecting malicious software via memory analysis. Various embodiments of malicious software detection are executable on a computing device. FIG. 2 and the following discussion provide a brief general description of a suitable computing environment in which such a computing device can be implemented. Although not required, various aspects of detecting malicious software via memory analysis can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, detecting malicious software via memory analysis can be practiced with other computer system configurations, including hand held devices, multi processor systems, microprocessor based or programmable consumer electronics, network PCs, minicomputers, mainframe computers, and the like. Further, detecting malicious software via memory analysis also can be practiced in distributed computing environments where tasks are performed by remote processing devices that are linked through a communications network. In a distributed computing environment, program modules can be located in both local and remote memory storage devices.

As shown in FIG. 2, an exemplary general purpose computing system includes a computing device 260 or the like, including a processing unit 221, a system memory 262, and a system bus 223 that couples various system components including the system memory to the processing unit 221. The system bus 223 may be any of several types of bus structures including a memory bus or memory controller, a peripheral bus, and a local bus using any of a variety of bus architectures. The system memory includes read only memory (ROM) 264 and random access memory (RAM) 225. A basic input/output system 266 (BIOS), containing basic routines that help to transfer information between elements within the computing device 260, such as during start up, is stored in ROM 264. In an example configuration, the ROM 264 comprises an uncorrupted operating system and, optionally, anomaly detection software, as described above.

The computing device 260 may further include a hard disk drive 227 for reading from and writing to a hard disk (hard disk not shown), a magnetic disk drive 228 (e.g., floppy drive) for reading from or writing to a removable magnetic disk 229 (e.g., floppy disk, removal storage), and an optical disk drive 230 for reading from or writing to a removable optical disk 231 such as a CD ROM or other optical media. The hard disk drive 227, magnetic disk drive 228, and optical disk drive 230 are connected to the system bus 223 by a hard disk drive interface 232, a magnetic disk drive interface 233, and an optical drive interface 234, respectively. The drives and their associated computer readable media provide non volatile storage of computer readable instructions, data structures, program modules and other data for the computing device 260. Although the exemplary environment described herein employs a hard disk, a removable magnetic disk 229, and a removable optical disk 231, it should be appreciated by those skilled in the art that other types of computer readable media which can store data that is accessible by a computer, such as magnetic cassettes, flash memory devices, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 229, optical disk 231, ROM 264, or RAM 225, including an operating system 235, one or more application programs 236, other program modules 237, and program data 238. For example, application programs for performing the functions associated with detecting malware via memory analysis, as described herein, can be store in various combinations of the hard disk, the magnetic disk 229, the optical disk 231, the ROM 264, or the RAM 225. A user may enter commands and information into the computing device 260 through input devices such as a keyboard 240 and pointing device 242 (e.g., mouse). Other input devices (not shown) may include a microphone, joystick, game pad, satellite disk, scanner, or the like. These and other input devices are often connected to the processing unit 221 through a serial port interface 246 that is coupled to the system bus, but may be connected by other interfaces, such as a parallel port, game port, or universal serial bus (USB). A monitor 247 or other type of display device is also connected to the system bus 223 via an interface, such as a video adapter 248. In addition to the monitor 247, computing devices typically include other peripheral output devices (not shown), such as speakers and printers. The exemplary system of FIG. 2 also includes a host adapter 255, Small Computer System Interface (SCSI) bus 256, and an external storage device 262 connected to the SCSI bus 256.

The computing device 260 may operate in a networked environment using logical connections to one or more remote computers, such as a remote computer 249. The remote computer 249 may be another computing device (e.g., personal computer), a server, a router, a network PC, a peer device, or other common network node, and typically includes many or all of the elements described above relative to the computing device 260, although only a memory storage device 250 (floppy drive) has been illustrated in FIG. 2. The logical connections depicted in FIG. 2 include a local area network (LAN) 251 and a wide area network (WAN) 252. Such networking environments are commonplace in offices, enterprise wide computer networks, intranets and the Internet.

When used in a LAN networking environment, the computing device 260 is connected to the LAN 251 through a network interface or adapter 253. When used in a WAN networking environment, the computing device 260 can include a modem 254 or other means for establishing communications over the wide area network 252, such as the Internet. The modem 254, which may be internal or external, is connected to the system bus 223 via the serial port interface 246. In a networked environment, program modules depicted relative to the computing device 260, or portions thereof, may be stored in the remote memory storage device. It will be appreciated that the network connections shown are exemplary and other means of establishing a communications link between the computers may be used.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 221, the memory (both ROM 264 and RAM 225), the basic input/output system (BIOS) 266, and various input/output (I/O) devices such as a keyboard 240, a mouse 242, a monitor 247, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users).

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. The purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

In an example configuration, the computing device 260 comprises anomaly detector 202. The anomaly detector 202 is coupled to the computing device 260 via the system bus 223. The anomaly detector 202 analyzes selected data for anomalies/malware, as described above. The anomaly detector may comprise memory therein, such as ROM for example, for storing an uncorrupted operating system and, optionally, anomaly detection software. In an example embodiment, he uncorrupted operating system and anomaly detector can reside in the BIOS 266. Alternatively or additionally, as described above, the anomaly detector 202 can receive an uncorrupted operating system and anomaly detection software via the system bus 223. For example, the dedicated device can comprise read only memory (ROM) having an uncorrupted operating system stored therein.

In an example embodiment, the processing portion 221 performs the functions associated with detecting malicious software via memory analysis. For example, the processing portion 221 can select data to be analyzed for anomalies and provide the selected data for storage in a designated storage location. The designated storage location can include a portion of the system memory 262 (e.g., a partition), the anomaly detector 202, memory in the hard drive 227, the removable storage 229, the optical storage 231, a flash memory device, or a combination thereof, for example. In an example embodiment, the processing portion 221 can analyze the selected data utilizing the uncorrupted operating system, detect anomalies, and remove anomalies/malware, as described above.

While it is envisioned that numerous embodiments of detecting malicious software are particularly well-suited for computerized systems, nothing in this document is intended to limit malicious software detection to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for detecting malicious software, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for detecting malicious software.

The program(s) can be implemented in assembly or machine language, if desired. In any case, the language can be a compiled or interpreted language, and combined with hardware implementations. The methods and apparatuses for detecting malicious software also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for detecting malicious software. When implemented on a general-purpose processor, the program code combines with the processor to provide a unique apparatus that operates to invoke the functionality of detecting malicious software. Additionally, any storage techniques used in connection with detecting malicious software can invariably be a combination of hardware and software.

While detecting malicious software has been described in connection with the example embodiments of the various figures, it is to be understood that other similar embodiments can be used or modifications and additions can be made to the described embodiments for performing the same functions for detecting malicious software without deviating therefrom. Therefore, detecting malicious software as described herein should not be limited to any single embodiment, but rather should be construed in breadth and scope in accordance with the appended claims.

What is claimed:

1. A method for detecting malicious software, the method comprising:
storing, in a designated storage, selected data for analysis, wherein the selected data is selected from a system having a first operating system;
receiving a second operating system different from the first operating system, wherein the second operating system is an uncorrupted operating system; and
analyzing the selected data for an anomaly, utilizing the second operating system.

2. A method in accordance with claim 1, further comprising:
determining if an anomaly is detected in the selected data; and
if an anomaly is detected:
removing malicious software associated with the detected anomaly from the selected data for providing clean data; and
replacing the selected data in the system with the clean data.

3. A method in accordance with claim 1, further comprising:
determining if an anomaly is detected in the selected data; and
removing from the system malicious software associated with the detected anomaly.

4. A method in accordance with claim 1, the designated storage comprising at least one of a disk, a flash memory device, a portion of system memory of the system, and a dedicated device coupled to the system, wherein the dedicated device is dedicated to at least detecting an anomaly in data.

5. A method in accordance with claim 4, wherein the designated device is segregated from the system.

6. A method in accordance with claim 1, wherein the steps of storing, analyzing, and receiving are initiated by at least one of:
the system entering into a hibernation state;
the system exiting a hibernation state;
the system conducting a system restoration operation; and
a user of the system.

7. A method in accordance with claim 1, wherein the anomaly is indicative of rootkit.

8. A system for detecting malicious software, the system comprising:
a processing portion for:
providing to a designated storage, selected data for analysis, wherein:
the selected data is selected from a system memory of the system; and
the system comprises a first operating system; and
analyzing the selected data for an indication of malicious software, utilizing an uncorrupted second operating system other than the first operating system; and
the designated storage for storing the selected data.

9. A system in accordance with claim 8, the processing portion further for, if an indication of malicious software is detected in the selected data:
removing the malicious software from the selected data for providing clean data; and
replacing the selected data in the system with the clean data.

10. A system in accordance with claim 8, the processing portion further for, if an indication of malicious software is detected in the selected data, removing from the system the malicious software associated with the detected anomaly.

11. A system in accordance with claim 8, wherein the designated storage comprises at least one of a disk, a flash memory device, and a portion of system memory of the system.

12. A system in accordance with claim 11, wherein the portion of system memory comprises a partition of system memory.

13. A system in accordance with claim 8, further comprising a dedicated device, wherein the dedicated device is dedicated to at least detecting an indication of malicious software in data.

14. A system in accordance with claim 13, wherein the designated device is segregated from the system.

15. A system in accordance with claim 8, the processor portion further for providing the selected data to the designated storage upon the occurrence of at least one of:
the system entering into a hibernation state;
the system exiting a hibernation state;
the system conducting a system restoration operation; and
initiation by a user of the system.

16. A system in accordance with claim 8, wherein the malicious software comprises a rootkit.

17. A computer-readable medium having computer-executable instructions thereon for detecting malicious software, the computer-executable instructions for performing the steps of:
storing, in a designated storage, selected data for analysis, wherein the selected data is selected from a system having a first operating system;
receiving a second operating system different from the first operating system, wherein the second operating system is an uncorrupted operating system; and
analyzing the selected data for an indication of malicious software, utilizing the second operating system.

18. A computer-readable medium in accordance with claim 17, the computer-executable instructions further for:
if an indication of malicious software is detected in the selected data, performing at least one of:
a)removing the malicious software from the selected data for providing clean data; and
replacing the selected data in the first system with the clean data; and
b) removing from the system the malicious software associated with the detected anomaly.

19. A computer-readable medium in accordance with claim 17, the designated storage comprising at least one of a disk, a flash memory device, a portion of system memory of the system, and a dedicated device coupled to the first system, wherein:
the dedicated device is dedicated to at least detecting an indication of malicious software in data; and
the designated device is segregated from the first system.

20. A computer-readable medium in accordance with claim 17, wherein the steps of storing, analyzing, and receiving are initiated by at least one of:
the system entering in a hibernation state;
the system exiting a hibernation state;
the system conducting a system restoration operation; and
a user of the first system.
